(19) United States
(12) Patent Application Publication
(10) Pub. No.: US 2003/0028584 A1
(43) Pub. Date: Feb. 6, 2003

(54) System and method for providing network management

(76) Inventors: Mark Coniglio, New York, NY (US); Kevin Cunningham, New York, NY (US); Eric Singer, Brooklyn, NY (US); Jill Szuchmacher, New York, NY (US)

Correspondence Address: KENYON & KENYON, 1500 K STREET, N.W., SUITE 700, WASHINGTON, DC, 20005, US

(21) Appl. No.: 10/194,878

(22) Filed: Jul. 15, 2002

Related U.S. Application Data
(60) Provisional application No. 60/304,756, filed on Jul. 13, 2001.

(51) Int. Cl. G06F 15/16

(52) U.S. Cl. 709/200

(57) ABSTRACT

A method and system for allowing multiple streams of media to be played back in synchrony among machines distributed on a network and allowing for on-the-fly redundant backup if one or more machines fail, while minimizing downtime in event of failure.

### CROSS-REFERENCE TO RELATED APPLICATION

This application claims the benefit under 35 U.S.C. § 119(e) of U.S. Provisional Application No. 60/304,756, filed Jul. 13, 2001, which is hereby incorporated by reference in its entirety. This application is also related to U.S. patent application Ser. No. 09/618,278, filed Jul. 18, 2000, which is hereby incorporated by reference in its entirety.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND OF THE INVENTION

The current practice of synchronizing media requires the use of general purpose computers and a variety of hardware devices that can deliver the desired media: DVD or Hard Disk Recorders/Players to deliver video, music synthesizers or samplers to deliver audio, etc. Each of these requires the general purpose computer to deliver control signals, either via an RS-232 serial port or a MIDI port, to tell them what media to play, when to start playing, when to locate to a new portion of the media, when to stop. The most common methodology is to have a “timeline” on the general purpose computer within which the user places markers indicating the time at which commands will be sent to the external devices. When the user tells the timeline to “play”, the computer simply sends the individual commands to the appropriate device at the correct time. Methods currently in use do not provide the ability for the general purpose computer to sense when one of these external devices has failed and also does not provide any methodology for handling failure situations.

Accordingly, there is a need in the art for a system and method that provides for synchronous data stream playback management distributed over a network with full system redundancy.

### SUMMARY OF THE INVENTION

The present invention is directed to a system and method for allowing multiple streams of media to be played back in synchrony among machines distributed on a network and allowing for on-the-fly redundant backup if one or more machines fail, while minimizing downtime in event of failure.

### BRIEF DESCRIPTION OF THE DRAWINGS

FIG. 1 is a block diagram that depicts a user computing device in accordance with an embodiment of the present invention.

FIG. 2 is a block diagram that depicts a network architecture in accordance with an embodiment of the present invention.

FIG. 3 is a screen shot of a network setup window in accordance with an embodiment of the present invention.

FIGS. 4a-4c are screen shots illustrating machine selection in accordance with an embodiment of the present invention.

FIG. 5 is a screen shot of an enable ports page in accordance with an embodiment of the present invention.

FIGS. 6a-6b are screen shots illustrating backup machine selection in accordance with an embodiment of the present invention.

FIG. 7 is a screen shot of a map outputs ports page in accordance with an embodiment of the present invention.

FIG. 8 is a screen shot of a configure connections page in accordance with an embodiment of the present invention.

FIG. 9a is a screen shot of a device selection drop down box in accordance with an embodiment of the present invention.

FIG. 9b is a screen shot of a configure connections page in accordance with an embodiment of the present invention.

FIG. 10a is a representation of click and drag functionality of connecting ports in accordance with an embodiment of the present invention.

FIG. 10b is a screen shot of a configure connections page in accordance with an embodiment of the present invention.

FIG. 11 is a flow chart of steps illustrating network management in accordance with an embodiment of the present invention.

FIG. 12 is a flow chart of steps illustrating network management in accordance with an embodiment of the present invention.

FIG. 13 is a flow chart of steps illustrating network management in accordance with an embodiment of the present invention.

FIG. 14 is a flow chart of steps illustrating network management in accordance with an embodiment of the present invention.

FIG. 15 is a flow chart of steps illustrating network management in accordance with an embodiment of the present invention.

### DETAILED DESCRIPTION

### Architecture

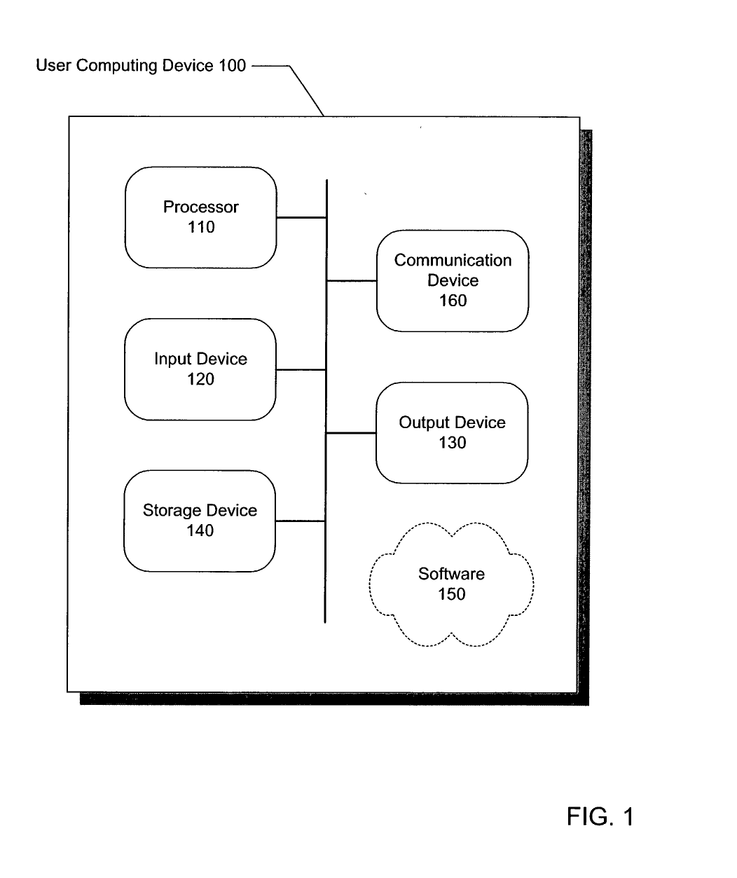

FIG. 1 is a block diagram depicting the internal structure of a user computing device in accordance with an embodiment of the present invention. UCD 100 may be a personal computer, handheld personal digital assistant (“PDA”), or any other type of processor-based device. UCD 100 may include a processor 110, input device 120, output device 130, storage device 140, software 150, and communication device 160.

Input device 120 may include a keyboard, mouse, pen-operated touch screen, voice-recognition device, or any other device that provides input from a user. Output device 130 may include a monitor, printer, disk drive, speakers, or any other device that provides tangible output to user. Storage device 140 may include volatile and nonvolatile data storage. Volatile data storage includes RAM, a cache, or any storage medium that temporarily holds data while being processed; nonvolatile data storage includes a hard drive, CD-ROM drive, tape drive, removable storage disk, or any other non-temporary storage medium. Communication device 160 may include a modem, network interface card, or any other device capable of transmitting and receiving signals over a network.

Software 150 contains the logic used by the network process of the present invention, as provided herein. Software 150 may take the form of custom-written programs and libraries that are either interpreted or compiled, and may be written in any programming language, such as C, C++, or JAVA.

One skilled in the art would appreciate that the components of UCD 100 may also be connected wirelessly, possibly through an infrared connection.

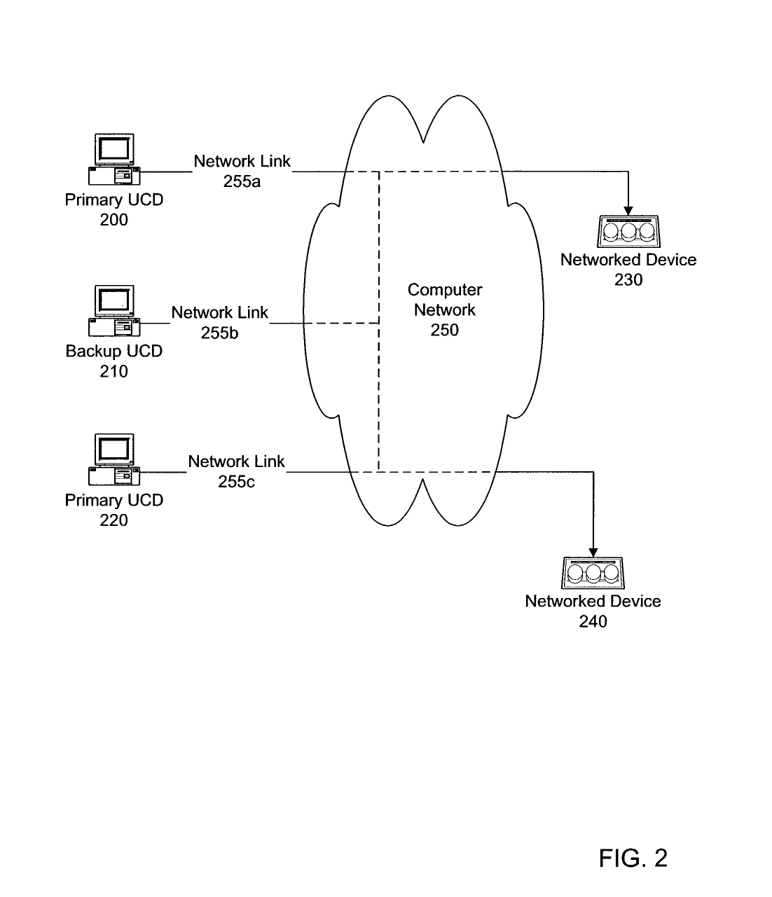

FIG. 2 illustrates a network architecture between primary UCDs 200 and 220, networked devices 230 and 240 and backup UCD 210, in accordance with an exemplary embodiment of the present invention. According to this embodiment, primary UCDs 200 and 220 synchronize their data stream outputs (e.g., audio, video, machine/device control, network protocol) to networked devices 230 and 240 over computer network 250 according to a playback assignment file, or timing file, stored on each system. Backup UCD 210 provides full system redundancy because it has the ability to take over the data stream output functionality of either primary machine should one fail, as discussed below.

Further explanation as to the mechanics of data stream scheduling and output on a computer can be found in the above-referenced related U.S. patent application, incorporated by reference. Computer network 250 may include any network, such as a wide-area network (WAN) (i.e., the Internet) and local-area network (i.e., an intranet). Computer network 250 may implement any number of communications protocols, including, for example, TCP/IP (Transmission Control Protocol/Internet Protocol) and UDP (User Datagram Protocol). Network link 255 may include, for example, telephone lines, DSL (Digital Subscriber Line), cable networks, T1 or T3 lines, wireless connections, or any other arrangement that allows for the transmission and reception of network or data signals.

### Configuration User Interface

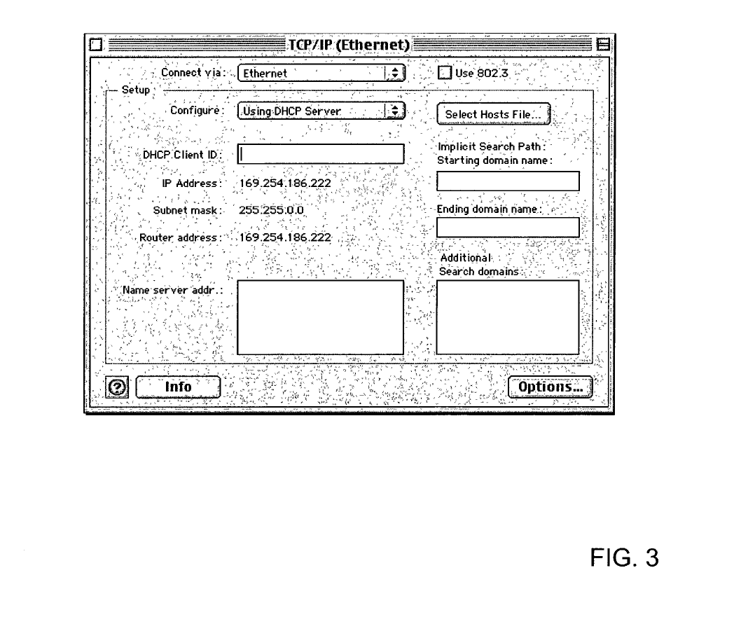

FIGS. 3-10 illustrate an embodiment of the present invention in which a user sets up a network show through a user interface on her computer. Software 150 launches a networking wizard (i.e., user interface component of software 150) to guide the user through the set-up process.

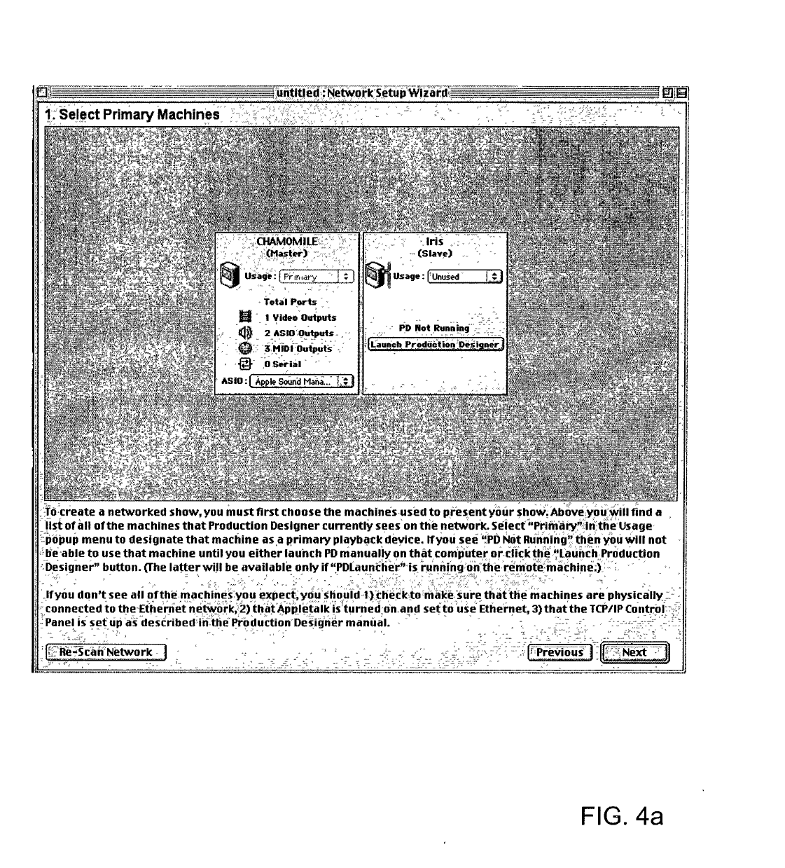

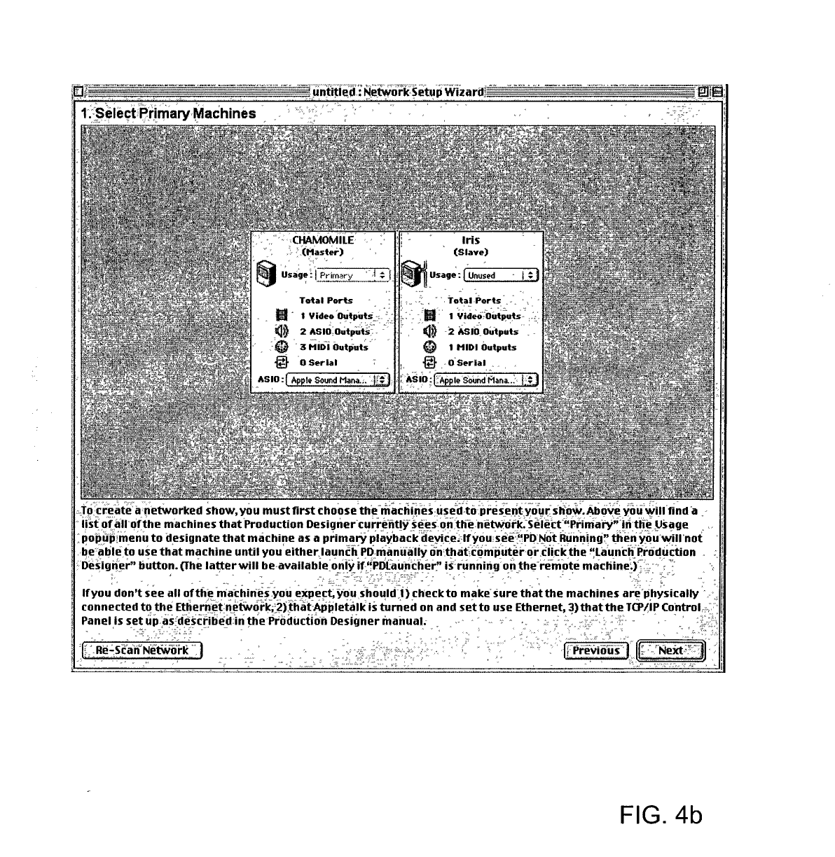

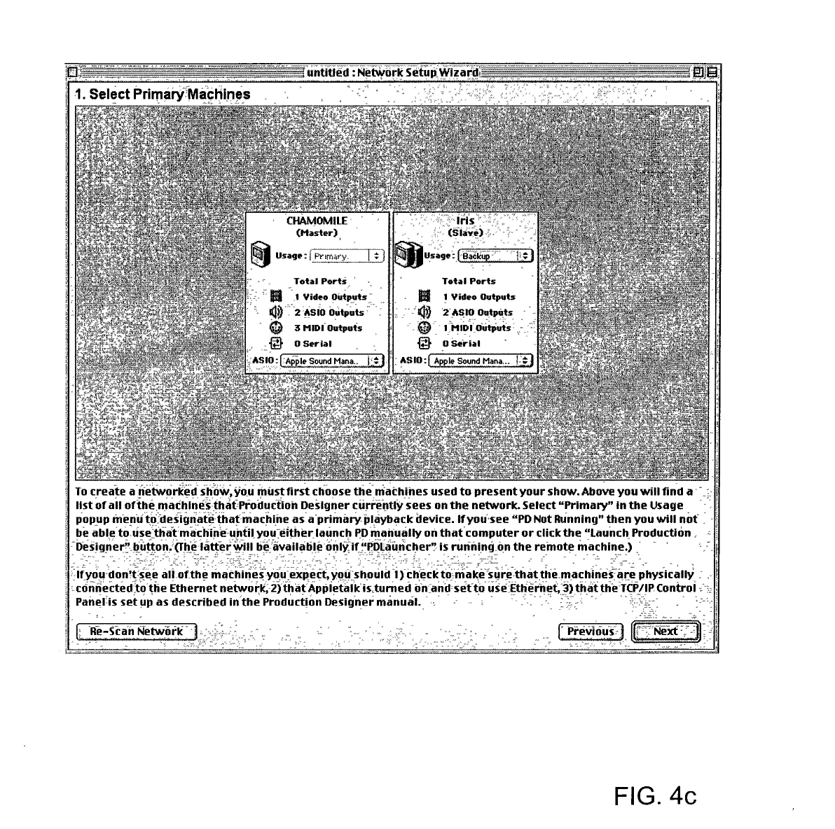

Once the user has selected the appropriate network connection for her computer (FIG. 3), the wizard scans the network for other connected computers and displays them to the user as shown in FIGS. 4a-c. The wizard indicates whether the machine is unused, primary, or backup as well as the name of the machine, whether software 150 is running, and what outputs are available. The default state of the machine used to configure the network is primary; the default state of any other machines on the network is unused. The user can set a machine's follow mode (play along, follow silently, don't follow) by virtue of the designation “primary”, “backup” or “unused”, respectively.

Thus, FIG. 4a displays to the user that two machines are connected to the network: Chamomile and Iris. Chamomile is a primary machine and Iris is unused and not running software 100. The user clicks the appropriate button on Iris to launch software 150, and the wizard now displays the available outputs of Iris (FIG. 4b). Since Iris is still unused, the user clicks the usage button and selects Iris to serve as a backup machine (FIG. 4c).

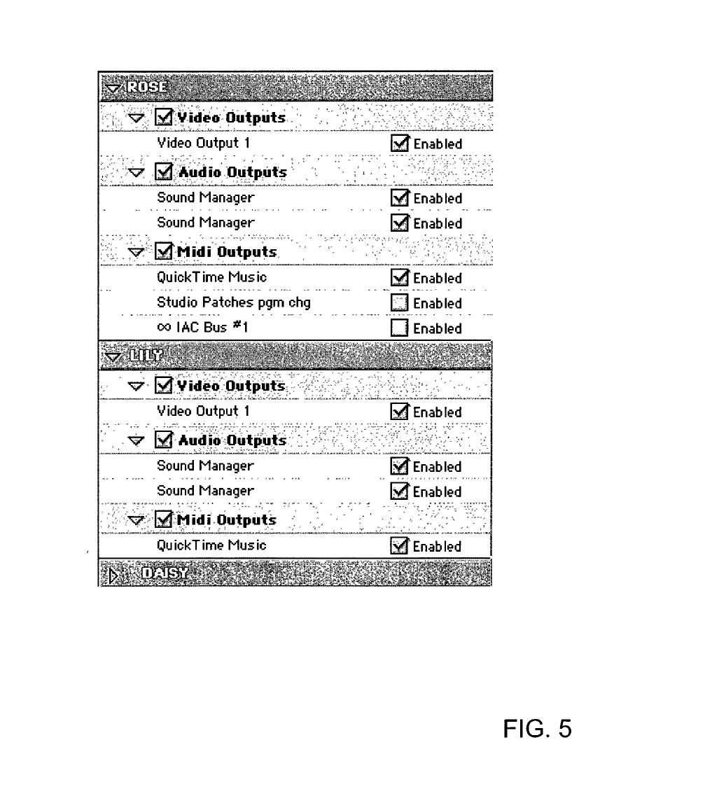

The wizard then displays an Enable Ports page (FIG. 5), which lists each primary computer and its available ports. This allows the user to enable the desired outputs by simply clicking in the “enabled” boxes next to the port descriptions.

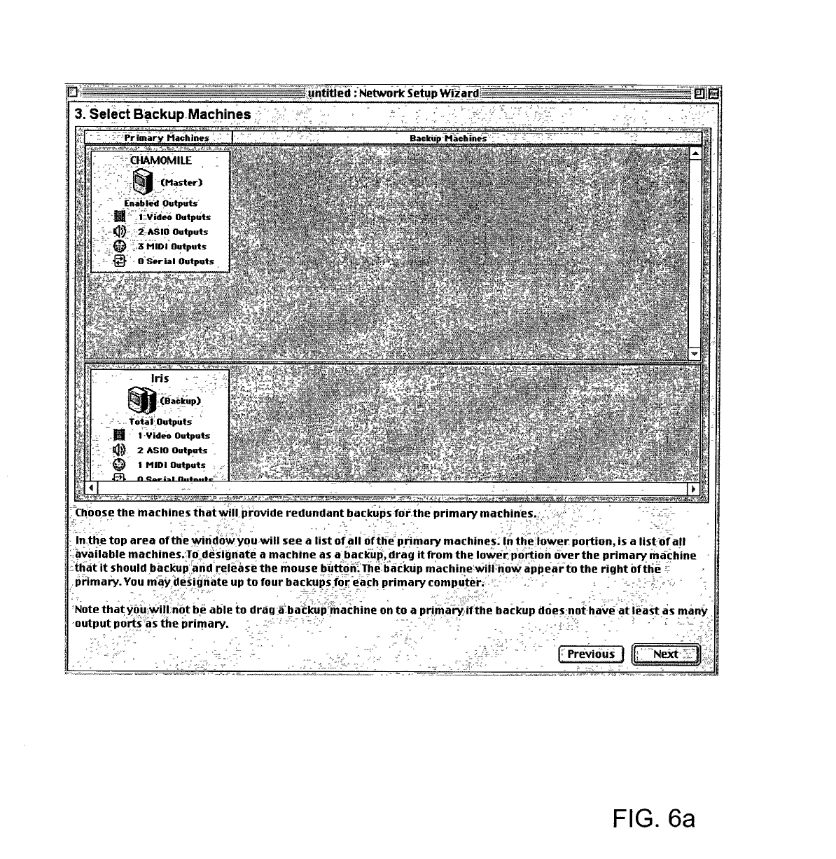

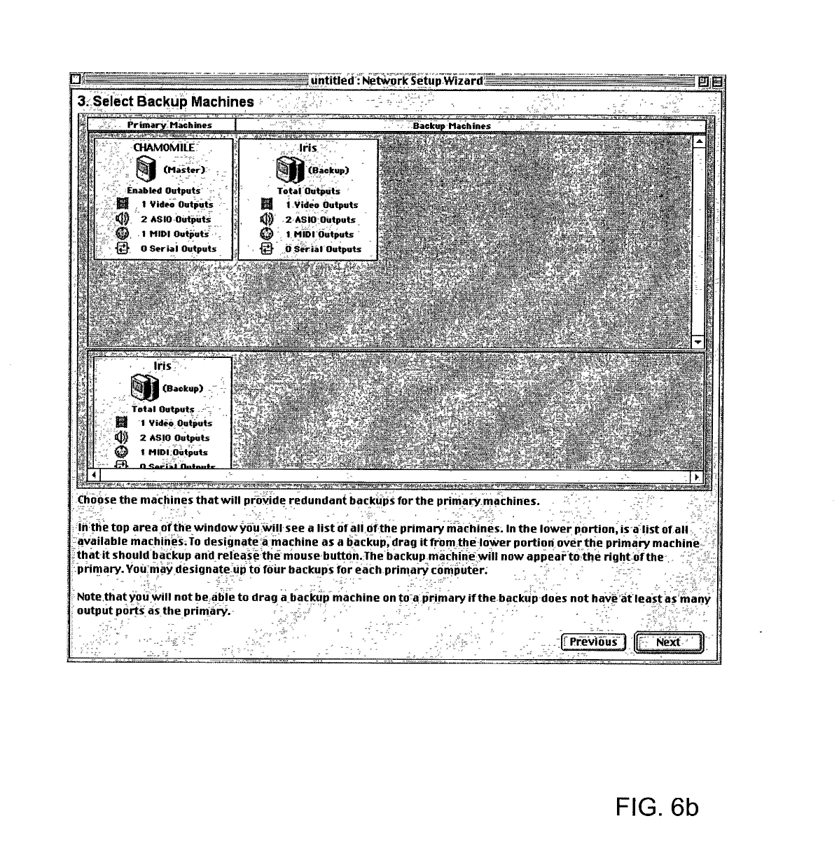

Next the wizard displays the Select Backup Machines page, where the primary computers are shown in the top part of the screen and the pool of potential backup machines are shown in the lower part of the screen (FIG. 6a). To select Iris as a backup machine for Chamomile, the user clicks on Iris and drags it next to Chamomile (FIG. 6b). Note that a backup machine should have the same available output ports as its primary, so that it may provide the same output through the same respective ports were the primary to fail. Also, nothing prevents one backup machine from serving as the backup for multiple primary machines.

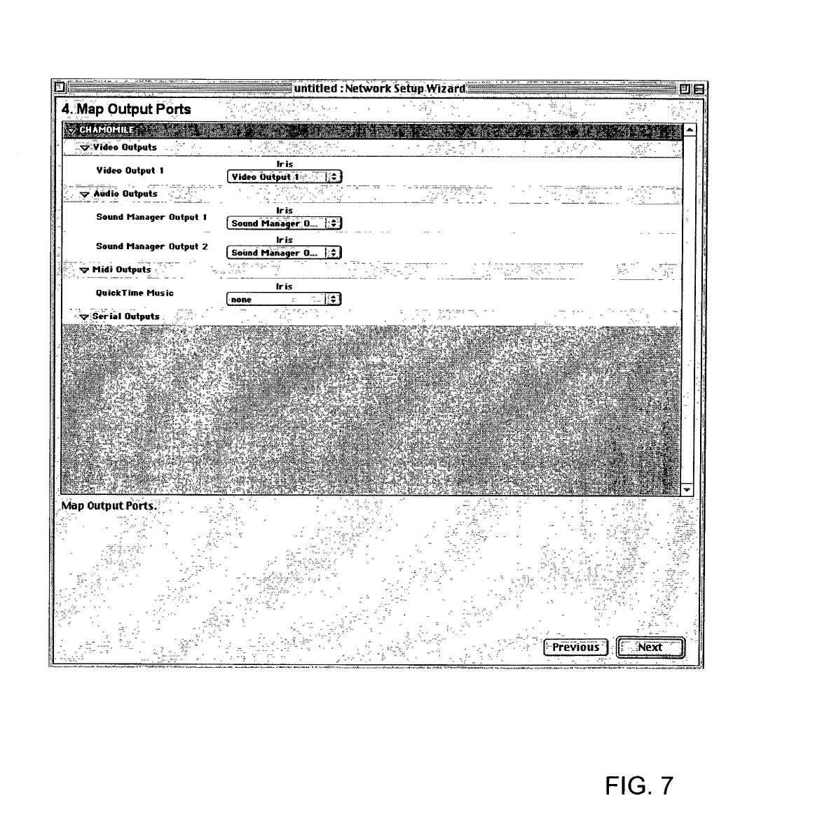

The wizard then displays the Map Output Ports page (FIG. 7). On this page the user sees the output ports of the primary machine listed on the left, and uses the pull down menus to designate which ports on the backup machine to map to the output ports of the primary machine in the event that the system redundancy feature of the network needs to be used.

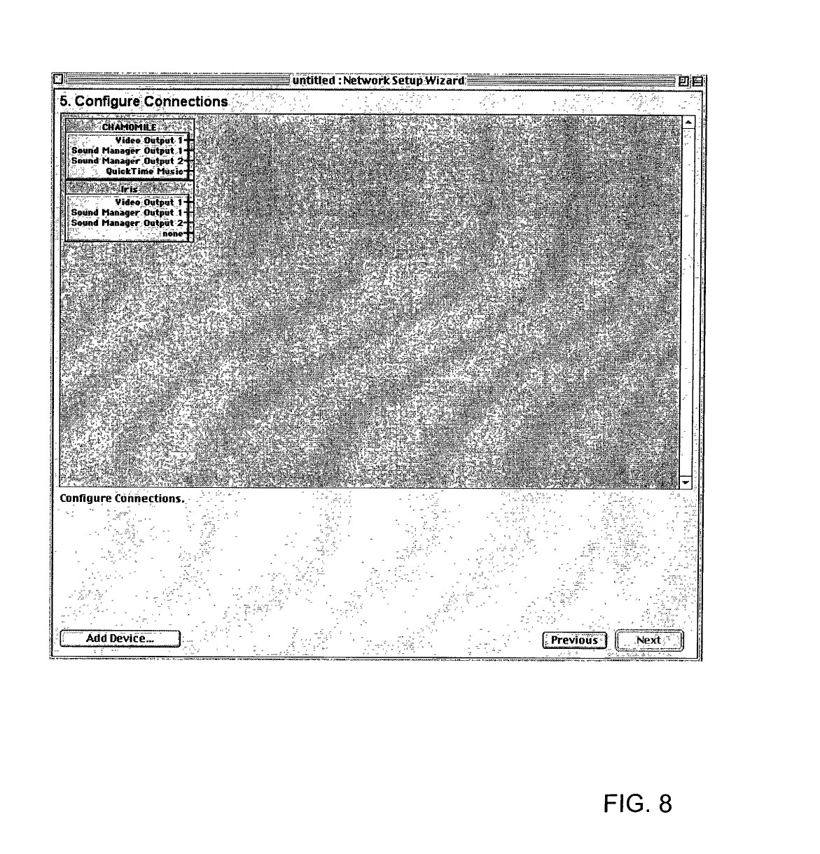

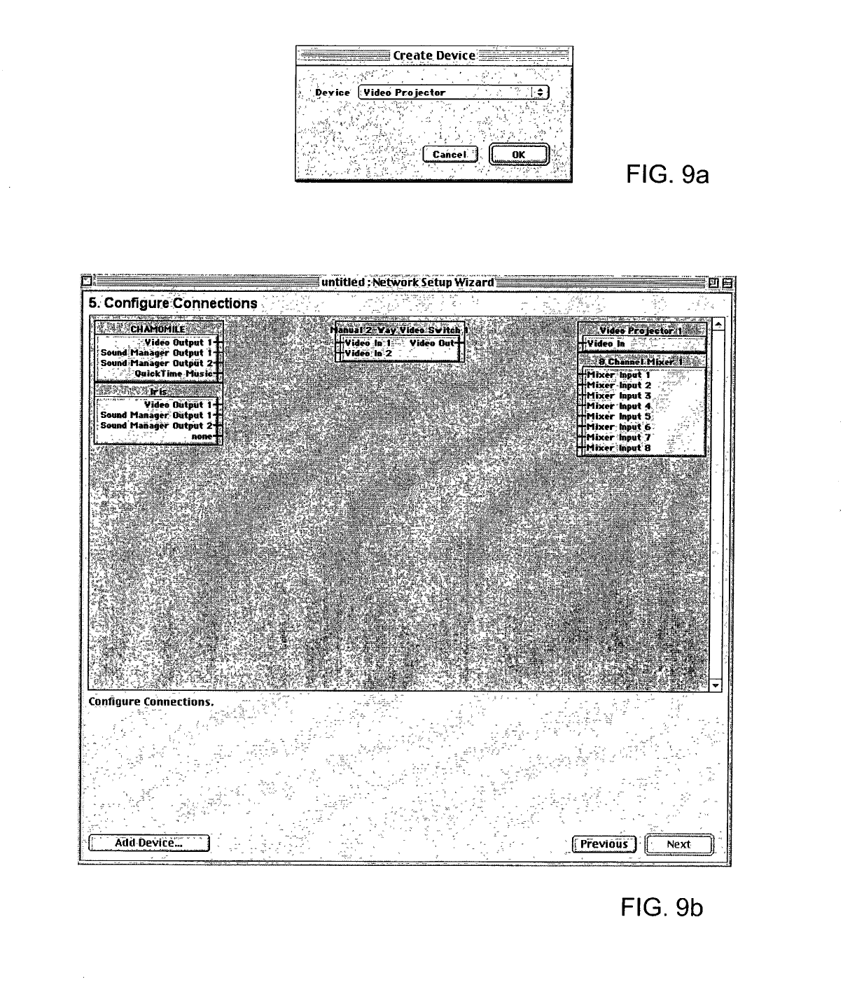

This leads to the Configure Connections page, which display the networked computers and their outputs on the left side of the screen (FIG. 8). Upon clicking the “Add Device” button at the bottom of the screen, a dialog box (FIG. 9a) pops up that asks the user to select a device to add. FIG. 9b shows the screen after the user finishes selecting devices (note that routers and switches appears in the middle, and output devices appear on the right).

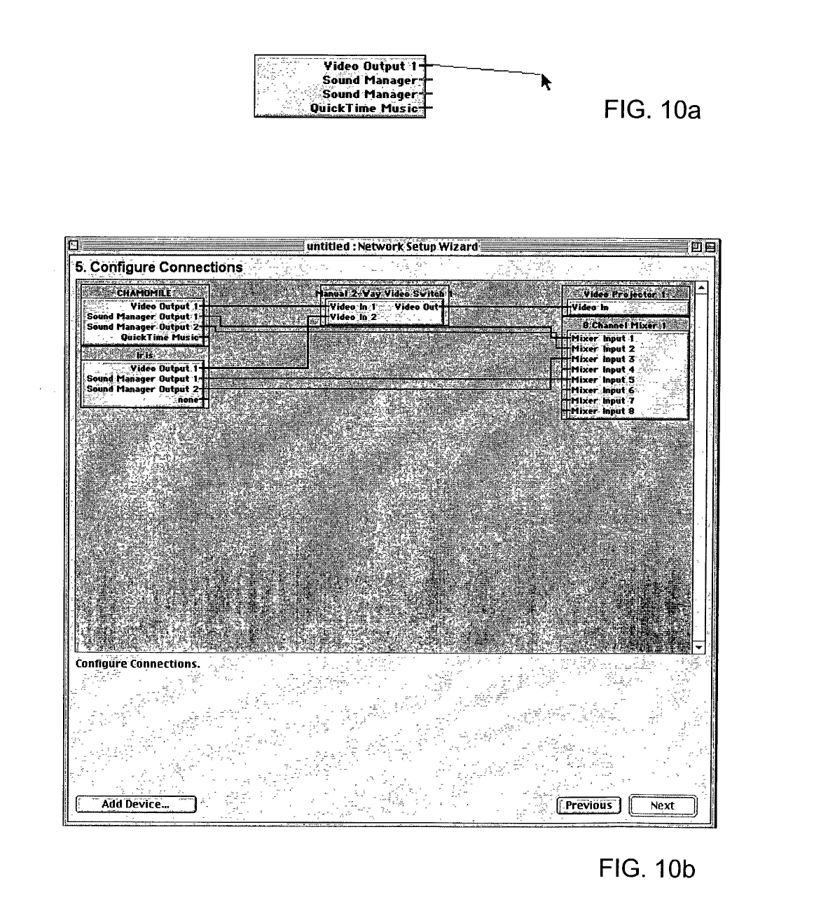

At this point, the user can connect the outputs on the left to a device on the right by simply clicking and dragging the line beside the output until it connects with the desired device of the right side of the screen, as illustrated by FIG. 10a. FIG. 10b shows a fully connected show configuration, where both the primary and backup have connected their Video Output 1 ports to the video projector's input port (via a 2-way switch, since the projector only has one input port), and their Sound Manager Output 1 ports to the 8 Channel Mixer's input ports.

Before the network is set up and ready to play, software 150 sends all machines the show file (i.e., playback assignment file) and makes sure each machine has the appropriate media files (i.e., content to be delivered during the show).

### Network Protocol

To ensure full system redundancy, each machine (primary and background) is either a master or a slave; the first machine to run the network wizard above becomes the master (e.g., Chamomile). The master configures slaves and groups based on network state, such as setup information and machines states (alive or dead). The master tells the slaves to preroll (i.e., prepare the content to be played in advance of the time it needs to be played), and when all prerolling is complete, the master instructs the slaves to play.

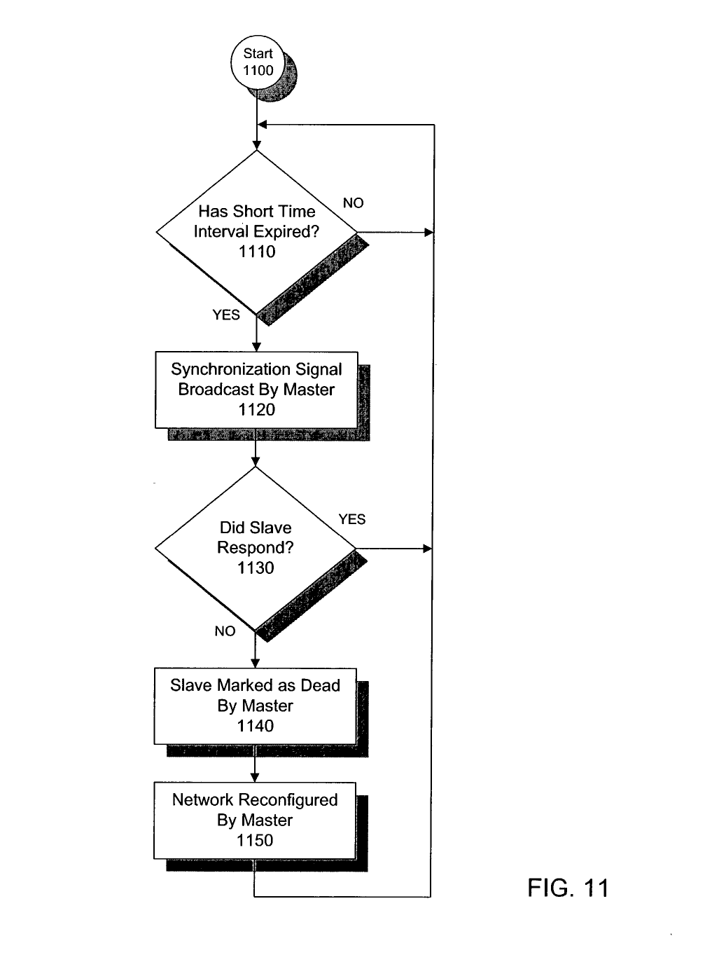

FIGS. 11-15 illustrate protocols utilized by both master and slave during playback through which full system redundancy is maintained. At a regular short time interval (step 1110), the master broadcasts a synchronization signal (“a tick” or “clock”) to the slaves (step 1120). If slave does not respond (step 1130), the slave is marked dead by the master (step 1140). Once it marks a slave dead, the master reconfigures the network (step 1150) by putting the backup machines into service for the dead primary (slave) machines and broadcasting the new state information.

In addition to an alive check, the tick may accomplish the following:

broadcast timing information

location in the show (or multiple independent locations due to multiple timeline architecture)

broadcast state info

whether it's currently playing or not

which other primaries machines are playing

which backups are playing (if any)

which backups are following silently (i.e., preroll only, no output)

as necessary during setup and state changes, other message are sent to keep all machines appraised of current network state

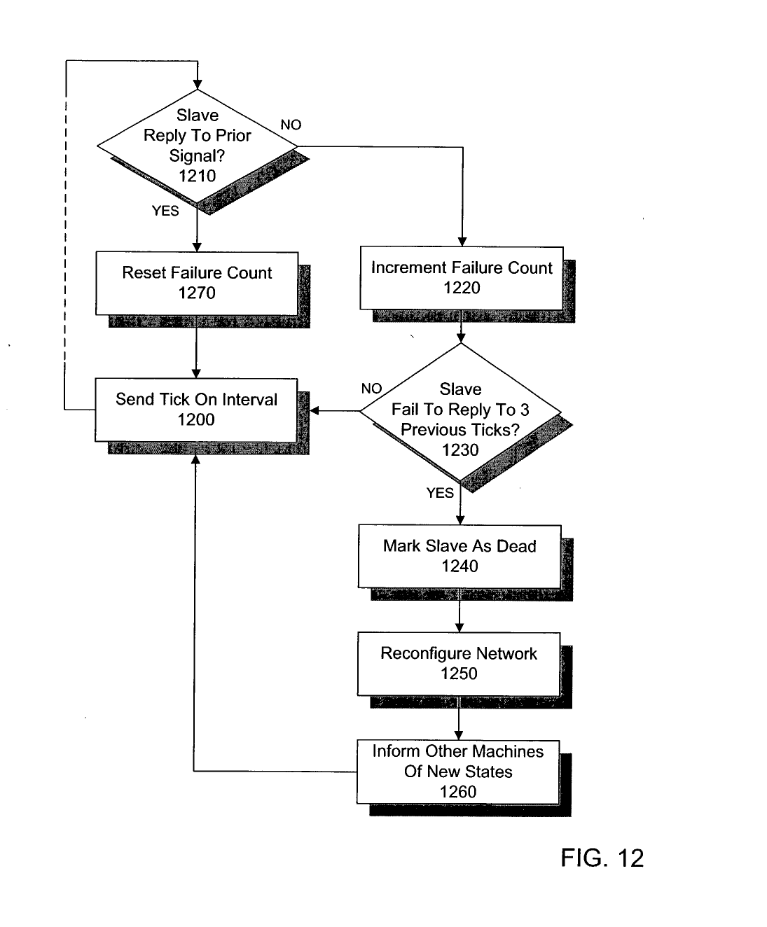

Since external factors, such as dropped packets, could prevent a slave from responding right away in step 1130, the master may impose certain conditions to ensure the slave is at fault before pronouncing the slave dead. For example, in FIG. 12, the master sends a synchronization signal every 100 milliseconds (step 1200). Just prior to sending the next signal, for each slave it checks for responses to the prior signal (step 1210). If a slave has not responded to the previous signal (sent 100 ms previously), a counter is incremented for that slave to indicate a missed response (step 1220). If the counter reaches three (indicating three missed responses) (step 1230), the slave is marked as dead (step 1240), the network is reconfigured (step 1250) and the rest of the machines are informed of the new network state (step 1260). It should be appreciated that all slaves in the network are simultaneously subject to steps 1210 through 1240 before the network is reconfigured. Conversely, if the slave has responded (step 1210), the miss counter is reset to zero (step 1270).

Conversely, upon receiving a network tick, the primary or backup machine may determine that its time location on the show timeline is out of synchronization with the time location of the master. Since external factors, such as delayed packets, could cause a slave to prematurely locate its timeline and related media, causing an unnecessary break in network data delivery, an embodiment of the present invention allows for the possibility that packets may be delayed in transit by ignoring discrepancies that fall within a specified range for a specified number of iterations.

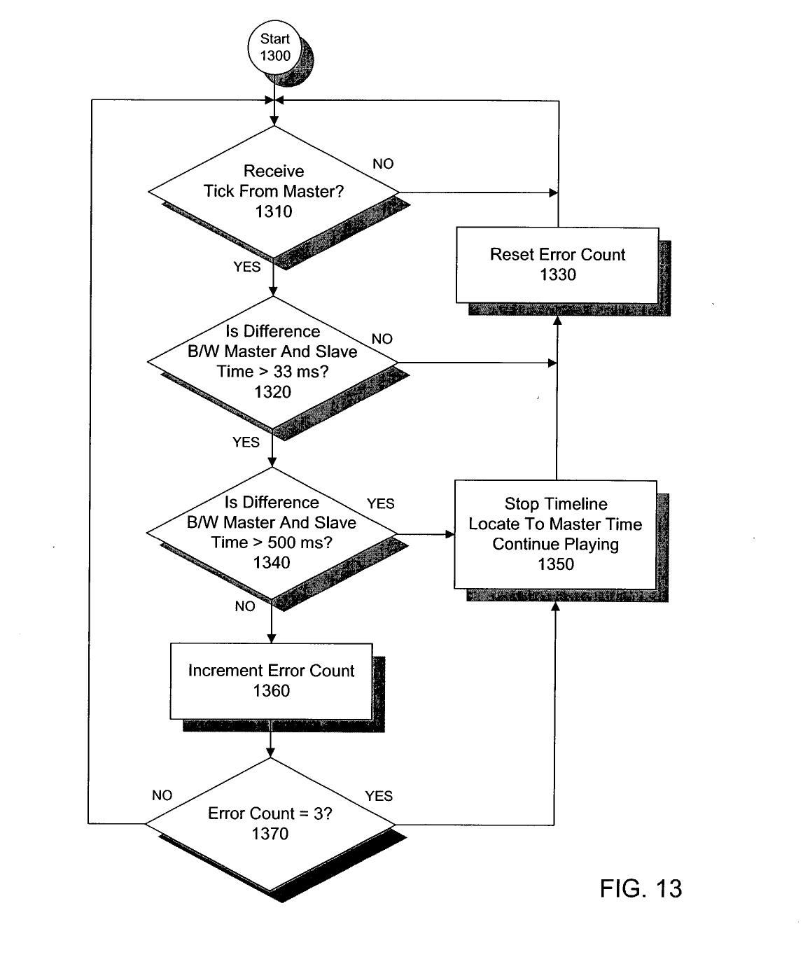

For example, in FIG. 13 if the discrepancy between the master and primary machine is less than 33 ms (step 1320), then the machines are considered to be in synchronization; the primary machine resets the delayed packet counter and takes no further action (step 1330). If the discrepancy is greater than 500 ms (step 1340), the machines are considered out of synchronization; the slave immediately locates its timeline and all related media to the time specified by the master clock tick, resumes playback from that point (step 1350), and resets the delayed packet counter (1330). If the discrepancy is greater than 33 ms but less than 500 ms, the slave assumes that it has received a delayed packet, increments the delayed packet counter (step 1360), and takes no further action at that time. If the delayed packet counter reaches a value of 3 (step 1370), then the machines are considered to be out of synchronization. The slave locates its timeline and all related media to the time specified by the master clock tick, resumes playback from that specified time (step 1350), and resets the delayed packet counter (step 1330). Again, it should be appreciated that the time periods specified herein are exemplary, as advances in computer and network architecture may dictate actual time periods used.

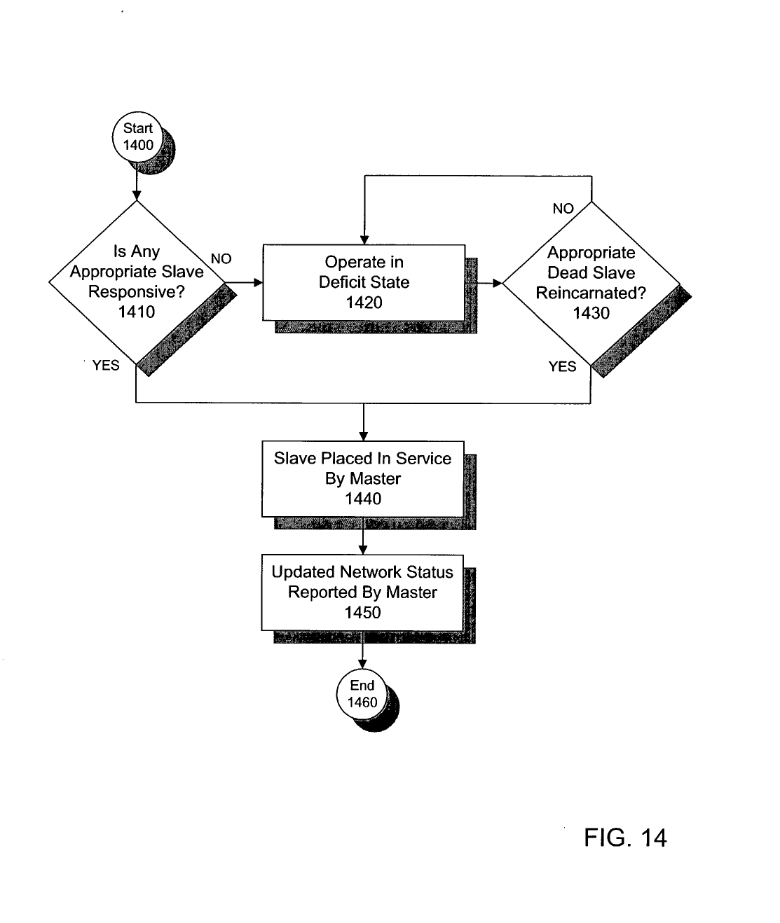

FIG. 14 represents the state of the network when a slave is marked dead. In reconfiguring a network, the master looks for a responsive slave to replace the dead slave (step 1410). If there is such a slave, the master places that slave in service (step 1440). However, if no slave responds to the master's signal (step 1410), the network operates in a deficit state (step 1420) until a dead slave is reincarnated (step 1430), at which time the reincarnated slave is placed in service by the master (step 1440). The master then reports an updated network status (step 1450). The master does not attempt to undo a deficit in this embodiment by moving active machines (i.e., those playing and outputting content for a particular group) to different groups because it assumes that this is a catastrophic situation. and gives priority to preserving continuity on active machines.

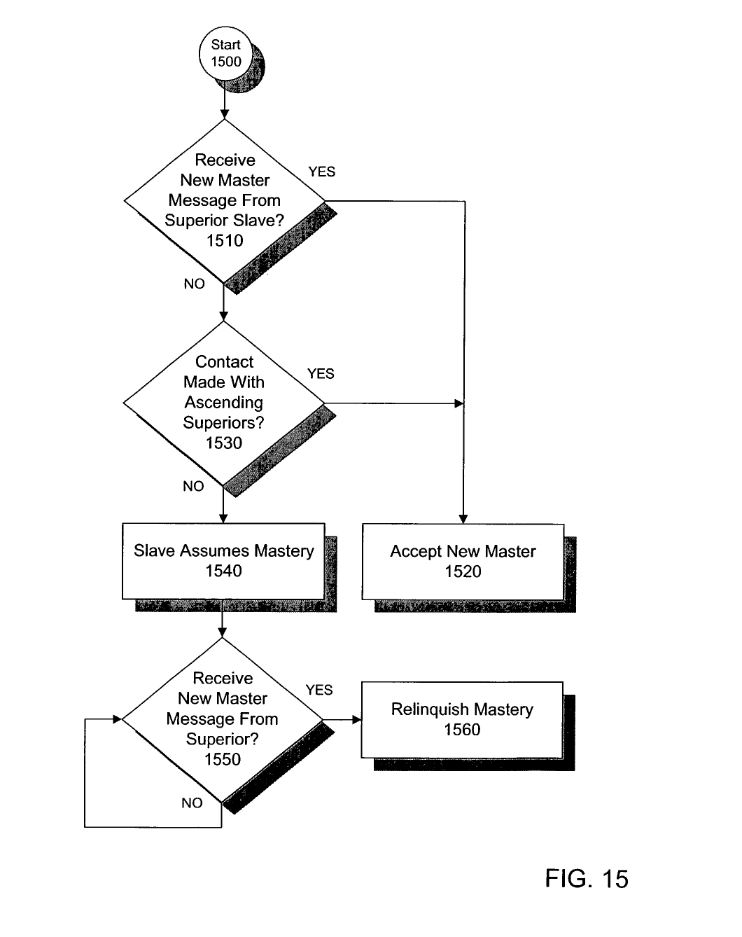

FIG. 15 covers the situation where the master becomes non-responsive. If a slave doesn't receive a synchronization signal from the master, it waits for a new master message from a superior slave (step 1510). If that message arrives, the slave accepts the new master (step 1520). If not, the slave attempts to make contact with its superior slaves in ascending order (step 1530). If contact is made, then the slave accepts the new master (step1520). If not, the slave assumes mastery (step 1540), but if the slave subsequently receives a new master message from a superior (step 1550), then the slave relinquishes mastery (step 1560).

Several embodiments of the invention are specifically illustrated and/or described herein. However, it will be appreciated that modifications and variations of the invention are covered by the above teachings and within the purview of the appended claims without departing from the spirit and intended scope of the invention.

What is claimed is:

1. A method for providing network management, comprising:
sending a playback assignment file over a network to a primary computer and a backup computer;
commencing playback of multiple data streams with the primary computer in accordance with timing information from the playback assignment file; and
sending signals to the primary computer and the backup computer during playback to synchronize each computer's timing with that of a master, the backup computer following along silently in the event the primary computer fails.

2. The method of claim 1, comprising:
determining if one of the primary computer or the backup computer is out of synchronization with the master; and if so,
stopping and locating its timeline to the time location specified by the master; and
continuing playback from the specified location.
